(19) United States
(12) Patent Application Publication
(10) Pub. No.: US 2006/0272587 A1
(43) Pub. Date: Dec. 7, 2006

(54) Rotating feed bunk

(76) Inventor: Roy Gordon, Douglas, WY (US)

Correspondence Address: STEPHEN M. NIPPER;DYKAS, SHAVER & NIPPER, LLP, PO BOX 877, BOISE, ID, 83701-0877, US

(21) Appl. No.: 11/349,308

(22) Filed: Feb. 6, 2006

Related U.S. Application Data
(60) Provisional application No. 60/688,656, filed on Jun. 7, 2005.

(51) Int. Cl. A01K 5/01

(52) U.S. Cl. 119/61.1

(57) ABSTRACT

The present invention is a feed bunk having a cover portion and a bunk portion. The feed bunk supported by at least one support leg. The feed bunk configured for rotation from a feeding position to a filling/loading position.

### PRIORITY

This application claims the priority date of the provisional application entitled ROTATING FEED BUNK filed by Roy Gordon on Jun. 7, 2005 with application Ser. No. 60/688,656, the disclosure of which is incorporated herein by reference.

### BACKGROUND OF THE INVENTION

1. Field of the Invention

The present invention generally relates to agricultural feeding troughs, more particularly relates to agricultural feeding troughs configured for protecting the contents therein thereby preventing harm and damage to animals using said feed bunks and saving feed.

2. Background Information

Traditional feed bunks are typically comprised of metal drums cut in half axially to form at least one generally semi-cylindrical trough, such troughs typically further comprising a base for supporting the feeding trough up off the ground. Animal feed is one of the largest expenses of modern ranchers. It is in the rancher's best interest to ensure that they are maximizing the consumption of feed by their animals while simultaneously minimizing feed waste. Animals typically ruin a large portion of their feed (i.e. ground hay) by spilling it, standing in it, urinating in it, defecating on it, and otherwise contaminating it. In other cases feed is ruined by weather and environmental conditions such as rain, snow, and wind. Animal feed such as ground hay is particularly susceptible to being blown away. In most cases the feed is ruined because the feed bunk used does not effectively shelter the feed from the elements and the animals themselves, while still making the feed easily accessible to the animals.

Additionally, it can be inconvenient to load feed in the center feed bunks and ranchers may be required to clean up ruined or spilled feed.

In addition, some animals have extremely valuable coats. The animal's coat may be ruined or otherwise damaged if the animal is able to roll in the feed, as it eats from the bunk. In many cases, the feed is naturally matted in their coat while eating from the bunk. In some cases, the rancher must take valuable time to clean and groom the coat or cover it with garments for animals which are inconvenient and difficult to deal with. Dirty, damaged and/or stained coats produce poor quality wool.

There is a need in the art for a feed bunk that can address the problem of feed waste and ease of use for loading and feeding purposes.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is an improved feed bunk. The preferred embodiment of the present invention comprising of a rotating feed bunk configured for rotating from a feeding position to a filling position. The feed bunk comprising of a bunk portion attached to a cover portion. A pair of legs is pivotally connected there-to for allowing the bunk to pivot from the filling position to the feeding position, and even to a cleaning position.

In one embodiment of the present invention, the feed bunk comprises a fifty-five gallon steel drum which has an axial cut made through its axial surface as well as a portion of the junction between the side ends of the drum cut so that a cover portion can be formed by straightening said cut portion to form a cover. The remainder of the steel drum comprising a bunk portion.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustrated embodiments are examples of the present invention and do not limit the scope of the invention.

FIG. 1 shows a perspective view of one embodiment of the present invention shown in the feeding position.

FIG. 2 shows a cross sectional view of a second embodiment of the present invention in the feeding position.

FIG. 3 shows a perspective view of the embodiment of FIG. 1 in the filling position.

### DESCRIPTION OF THE PREFERRED EMBODIMENTS

While the invention is susceptible to various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

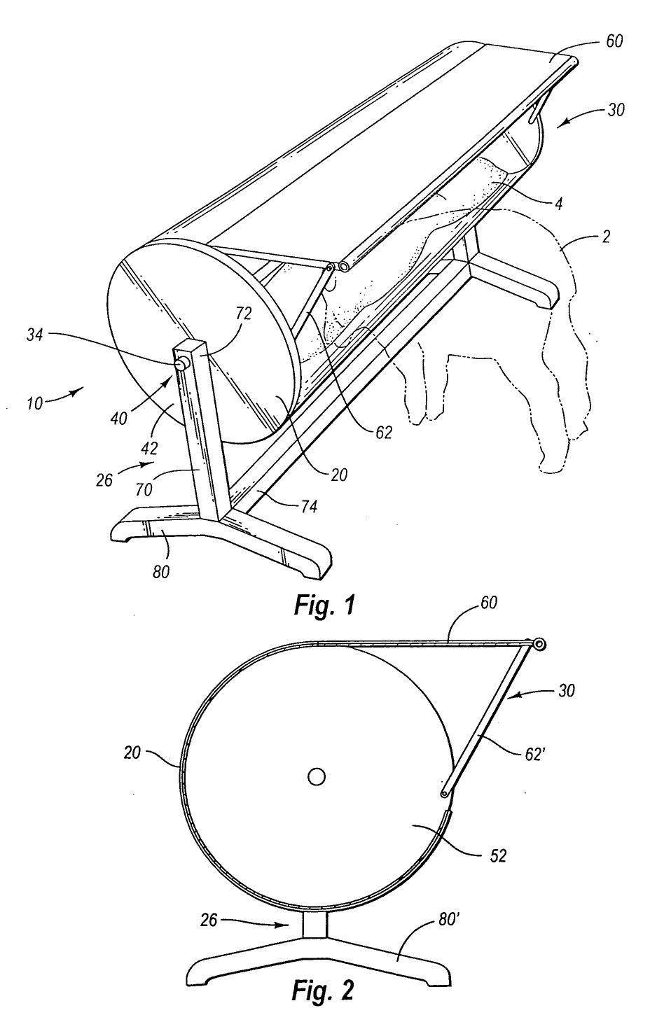

Referring to FIGS. 1-3, the present invention relates to an apparatus for feeding animals and more particularly to a rotating feed bunk 10 that prevents feed waste caused by the feeding animals and by weather conditions. Because of its structure, animals 2 are unable to ruin the feed 4 by standing in, urinating in, or defecating in it. Further, less feed is spilled out of the feed bunk (in certain embodiments) because of its design. Additionally, by limiting the animal's access to the feed, the animal's coat is much less likely to be damaged.

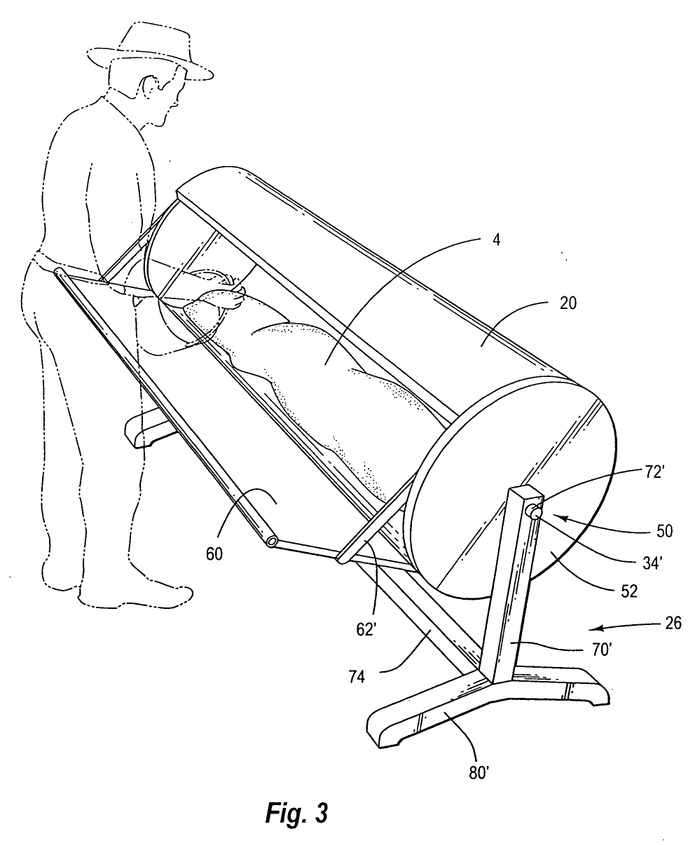

The rotating feed bunk 10 may be rotated between a loading position (shown in FIG. 3) and a feeding position (shown in FIGS. 1-2). Further, the feed bunk may (in some embodiments) be able to rotate past the loading position so that the contents of the bunk may be poured out upon the ground thereby cleaning out the bunk. When in the filling position, the cover portion essentially comprising a chute 60 facilitating the loading of the feedstuff (i.e., hay) into the bunk portion 20.

The rotating feed bunk 10 is supported by a base portion 26. The base portion 26 includes various pieces that are preferably constructed from metal, fiberglass, plastic or any other material of similar strength. The base portion 26 preferably rests on the ground and preferably includes at least one foot 80, 80′ at each end. The feet 80, 80′ give the rotating feed bunk 10 stability when the animals are feeding from the bunk and against wind, snow and other weather conditions. The feet 80, 80′ also prevent the rotating feed bunk 10 from tipping over when it is rotated between positions.

In one embodiment, the feet 80, 80′ at each end of the rotating bunk may be interconnected for added lateral stability. This interconnection is a stabilizing bar 74 preferably in the form of a pipe or bar that may be connected between the feet 80, 80′ and/or the support legs 70, 70′ extending there-from, whenever a user deems added stability necessary. The feet 80, 80′ may define a stabilizing receptacle for a stabilizing bar 74. The stabilizing bar 74 may simply slide through the stabilizing receptacle within the feet 80, 80′ or may be pinned or bolted to the feet 80, 80′ as well.

The feet 80, 80′ may also define stake openings. A user may decide that additional stability is needed by driving multiple stakes through the stake openings defined in the feet 80, 80′. In some conditions and for some animals, the feet 80, 80′ may need to be weighted to provide additional stability. If the user decides to interconnect multiple sections of the rotating feed bunk 10, the feet 80, 80′ may include a knuckle for connecting feet 80, 80′ from different sections of rotating feed bunk 10. The knuckle may be configured to allow one foot to rest on the other wherein gravity, stakes and/or weights will prevent the connected rotating bunks from tipping over and the knuckle will prevent the feet from the different sections from separating.

A support leg 70 extends normal to the feet 80, 80′. The support leg 70, 70′ is the support base of the bunk portion 20 and bares the weight of the rotating elements of the rotating feed bunk 10. In one embodiment, the support leg 70, 70′ is vertically adjustable to adapt to animals of varying heights and sizes. The support leg 70, 70′ may be slidably adjusted with a pin setting the support at a specified height. The support leg 70, 70′ connects to a pivoting connector 40, 50 support, preferably at the support leg's 70, 70′ top end 72, 72′. The pivoting connector 40, 50 is preferably a receptacle that bares the weight of a bunk portion 20 while still allowing it to pivot.

In the preferred embodiment, a first axle 34 extends from the first end 42 of the bunk portion 20 and a second axle 34′ extends from the second end 52 of the bunk portion 20. These axles 34, 34′ configured for rotating horizontally through the pivoting connectors 40, 50. In one embodiment, the pivot support is a Y that an axle of the bunk portion 20 rests and rotates on. In another embodiment, the pivot support defines an opening through which the axle passes. In another embodiment, the pivot support may be a closed receptacle enclosing the ends of the axle with bearings to ensure that the rotation about the pivot support is frictionless as possible. Other embodiments exist.

In one embodiment (not shown), a middle support may be used to slidably support the middle section of the bunk portion. The middle support is preferably a support with feet that extend to a concave support allowing the bunk portion to rotate while still providing load support. The concave support is preferably a material that allows the bunk portion to rotate with as little friction as possible. In one embodiment, the concave support includes bearings or wheels that allow the bunk portion to roll over the concave support.

The bunk portion 20 is preferably cylindrically shaped, but may also be square, elliptical, oblong or any other shape that is conducive to rotation and/or feeding animals. Preferably, the bunk portion 20 has a diameter sized for a range of animals. Animals such as cows and horses will need a larger diameter because of their size, and will need (depending on their size) variations in the height of the bunk off the ground. It is preferred that the bunk portion 20 itself defines a feed opening 30 that is also sized for different animals and their corresponding breed. A user will likely select a rotating feed bunk 10 with corresponding cylinder size based on the type of animals he/she is feeding. The rotating feed bunk 10 is potentially usable by any size of animal with slight adjustments.

When feed is stored within the bunk portion 20 it preferably rests on the bottom of the bunk portion 20. The feed opening 30 preferably allows the animal to put its head in the bunk portion 20 to feed, but does not provide excessive space for jostling or other unnecessary motion. Additionally, as most animals eat they tend to spill feed out of their mouth. This feed slides to the bottom of the bunk portion 20 because of the curved shape of the bunk portion 20, thereby conserving feed.

The bunk is preferably a fiberglass, plastic, vulcanized rubber, composite, polymer or other similar material that will not damage the animal's coat (the term “coat,” as used herein, referring to the animals natural coat, fur, fiber, wool, etc., and not an article of clothing worn by the animal, as is common in colder climates and for the protection of the natural coat). These materials are also preferable because the various forms of feed do not easily adhere to the bunk portion 20. The bunk portion 20 is also preferably water resistant, thereby preventing precipitation from damaging the feed. Any materials that would rust, flake or rub off with simple contact and discoloring the animal's coat would discourage a purpose of the rotating feed bunk and is therefore a less preferred embodiment.

A chute 60 extends from the upper portion bunk portion 20 directly above the feed opening 30 when the rotating feed bunk 10 is in the feeding position. This feature can be best seen in FIG. 2. The chute 60 serves various purposes. Most importantly, when the bunk portion 20 is in the feeding position (FIG. 1), it forms a cover which shelters the animal feed from precipitation, wind, and other weather conditions. Rain landing on the chute 60 is diverted away from the feed opening and feed, greatly decreasing the amount of precipitation that makes its way into the bunk portion 20. The chute 60 also provides a boundary so that the animals cannot climb inside or on the bunk portion 20 decreasing their ability to ruin the feed within the feed bunk. As the animals rub against the bunk portion 20 and the chute 60, feed is not matted into their fur because of the concave shape of the bunk portion 20 and surface properties. Support bars 62, 62′ may be provided for supporting the chute 60.

In one embodiment of the present invention, the bunk portion 20 comprises a plastic drum having a hole cut therein defining the feed opening 30. A galvanized portion of metal is then attached adjacent one side of the feed opening 30 thereby creating the chute/flap 60. As such, this embodiment illustrating that the present invention can comprise a mixture of construction materials (the disclosure is not limited to just metal construction or plastic construction, etc.).

When the bunk portion 20 is in the loading position (FIG. 3), the chute 60 serves as a loading chute extending the load area of the bunk portion 20 so that a user has easy access to the feed. The chute 60 is designed so that a user can take advantage of commonly available feed conveying apparatuses to feed his animals without getting out of his truck or tractor. The chute 60 is especially useful when multiple rotating feed bunks are interconnected.

Where there is likely to be a small separation space where the bunks interconnect, the chute extends out to cover the axial connection of the different bunks acting as a funnel or diverter so that feed landing on that section of the chute naturally slides to the corresponding bunk without spilling feed. This allows a user to continuously load feed over the entirety of the rotating feed bunk and corresponding chute without having to stop between sections. The funnel/diverter moves the feed to one side of the separation or the other without spilling the feed. This loading advantage saves time, effort, and money. Furthermore, if a user has numerous animals the user can load large amounts of feed in a very short time without worrying about spilling feed or otherwise wasting it during the loading process.

In the preferred embodiment, the rotating feed bunk 10 functions as a feed bunk as well as a fence in the pen, corral, pasture or other enclosure in which it is placed. As such, the farmer, standing outside of the enclosure, can rotate the feed bunk to its loading position and feed it, all without needing to enter within the enclosure itself. Because some animals (such as goats) are known to be able to jump over (or crawl under) small fences, the rotating feed bunk 10 may include fencing elements above or below the bunk portion 20 as needed to fully secure the animals within the enclosure.

The fencing elements above preferably extend from the support legs 70, 70′ and/or the adjacent fencing. In one embodiment, they include hanging elements that may pivot or swivel as the cylinders rotate between the two positions. The chute 60 may pass under the upper fencing elements without bothering or disturbing the use of the feed bunk.

The fencing elements below, in one embodiment, comprises the stabilizing bar 74 that extends from the support legs. In another embodiment the stabilizing bar 74 may include a hanging fence. The hanging fence may pivot or swivel as the cylinder is rotated between the two positions. The chute 60 and handle rotate under the stabilizing bar 74, hanging fence and handle without binding or disturbing the rotation of the rotating feed bunk 10 when moved between positions. The stabilizing bar 74 and base bar also function as a visual and psychological deterrent to the animal reminding them that the rotating feed bunk 10 is also a fencing structure besides functioning as their feed bunk.

The bunk portion preferably includes stops that are used to adjust the rotation of the bunk portion 20. This allows a user to select the angle of the feed opening 30 and chute 60 when in the feeding and loading position to eliminate feed waste. These stops are adjustable to fit the needs of the user and his or her respective animals. In one embodiment, the stops are adjustable bars on each end of the rotating feed bunk 10 extending from the axle 34 that abut the support when they have reached the preset fixed position preventing the bunk portion 20 from pivoting about the axle 34.

The bunk portion preferably includes baffles therein. The baffles strengthen the bunk and provide additional rigidity and torsional stiffness when the bunk is being rotated between the feeding and loading position. The baffles also provide a natural separation between animals. Some animals tend to be territorial or have a demeanor that may make it hard for other animals to feed at the same time. The baffles may be a continuous part of the bunk portion 20. In another embodiment, the baffles may easily be inserted within grooves defined within the bunk portion 20.

In another embodiment, the feed opening may be fitted with a grill. The grill is a vertical divider that further separates the animals from one another. The grill ensures that each animal is confined to a smaller space when feeding, allowing more animals to eat simultaneously. Additionally, when attached, the space between the grill is specifically designed so that certain animals can feed at the specified rotating feed bank. This allows a user to effectively separate where certain animals may feed and allows him to select the feed that a specific group of animals will or will not be able to access. For example, lambs may need special or distinct feed to facilitate their development and growth. Ewes in the same corral as the lambs are prevented from eating the lamb's special feed because they are unable to put their heads into the bunk portion 20 through the narrower cross-section of the grill.

One embodiment of the present invention is a manual bunk. The bunk portion preferably includes a handle for easily rotating the bunk from the feeding to loading position and vice versa.

In a second embodiment, the rotating feed bunk 10 may be rotated from a feeding position to a loading position by hand or by mechanical means, such as an electric motor. The electric motor may be attached to the base portion or to the rotational cylinder as needed. The electric motor can be run by a battery, fuel cell, wind power, or extension cord depending on the proximity to a power supply. In one embodiment, the axle 34 of the bunk portion 20 is operably connected to the electric motor by a chain or belt. A pulley or gear system may be attached to the axle 34 depending on the number of sections that will be driven by the motor. In some embodiments, multiple electric motors will be interconnected to ensure there is not excessive torque on the electric motor or bunk portions.

In another embodiment, the electric motor is controlled by a remote control similar to those used for garage doors. This allows a user to position the rotating feed bunks 10 in the loading position by pushing a button on the remote control without ever getting out of his tractor or truck. When the user has finished loading, he/she may simply push a button to rotate the rotating feed bunk 10 back to the feeding position.

It is preferred that the rotating feed bunk 10 be available in distinct sections. The sections may be interconnected if there is a need based on the number of animals and other uses. The bunks 10 may be connected by any number of manners including using simple male to female axial receivers using a pin. The various sections configured to rotate about a horizontal axis. In one embodiment, multiple axles are connected by means of a pinned socket or coupler. The axles may also be connected by means of bolting together the axles and an interconnected disk. In some instances a flexible coupler may be used to allow the alignment of the connected rotating feed bunks 10 to diverge and to allow rotating feed bunks 10 of different sizes and heights to be interconnected. Any sort of functional coupler is acceptable that is able to handle the load torque from the bunk portion 20 and feed stored within.

The bunk portion 20 of one embodiment of the present invention can be formed from a metal or plastic drum. Wherein an axial cut is made through the outside surface of the drum from the drums top end to the drums bottom end. Then a cut is made partial-circumferentially at or around each end from the axial cut to form a flapped portion, this flapped portion bent (and perhaps held) in a tangential fashion from the drum, thereby forming the feed opening and the chute discussed above.

The preceding description has been presented only to illustrate and describe embodiments of the invention. It is not intended to be exhaustive or to limit the invention to any precise form disclosed. Many modifications and variations are possible in light of the above teaching. The foregoing embodiments were chosen and described in order to illustrate principles of the invention and some practical applications. The preceding description enables others skilled in the art to utilize the invention in various embodiments and with various modifications as is suited to the particular use contemplated. It is intended that the scope of the invention be defined by the following claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A rotating feed bunk comprising:
a bunk portion for holding animal feed, wherein said bunk portion defines a feed opening therein, wherein said bunk portion pivotally connects with a base portion thereby enabling the bunk portion to rotate between a feeding position where livestock from feed upon said animal feed, and a loading position where an individual can load said animal feed into said bunk portion; and
a base portion for supporting said bunk portion above a ground surface, said base portion pivotally connected to said bunk portion.

2. The rotating feed bunk of claim 1, wherein pivoting connectors connect the base portion to the bunk portion.

3. The rotating feed bunk of claim 1, wherein said bunk portion pivots about a first axle extending from a first end of said bunk portion and a second axle extending from a second end of said bunk portion.

4. The rotating feed bunk of claim 3, wherein said base portion comprises a plurality of supports pivotally supporting said first axle and said second axle.

5. The rotating feed bunk of claim 1, wherein said base portion comprises a plurality of feet extending from a bottom end of said support portion providing additional stability to said support portion.

6. The rotating feed bunk of claim 1, wherein said bunk portion comprise a chute extending from said bunk portion above said feed opening when in said feeding position wherein said chute shelters said opening from the elements when said bunk portion is in its feeding position and said chute functions as a loading ramp when said bunk portion is in said loading position.

7. The rotating feed bunk of claim 1, further comprising a handle operably connected to said bunk portion for allowing a user to manually rotate said bunk portion between said feeding position and said loading position.

8. The rotating feed bunk of claim 1, further comprising a motor operably connected to said bunk portion wherein said motor rotates said bunk portion between said feeding position and said loading position.

9. The rotating feed bunk of claim 1, further comprising a stabilizing bar operably secured between said plurality of supports for providing added lateral stability to said plurality of supports.

10. The rotating feed bunk of claim 1, wherein said plurality of supports are vertically adjustable to raise or lower said bunk portion.

11. A rotating feed bunk comprising:
a bunk portion for holding animal feed, wherein said bunk portion defines a feed opening therein, wherein said bunk portion pivotally connects with a base portion thereby enabling the bunk portion to rotate between a feeding position where livestock feed upon said animal feed, and a loading position where an individual can load said animal feed into said bunk portion, wherein said bunk portion comprise a chute extending from said bunk portion above said feed opening when in said feeding position wherein said chute shelters said opening from the elements when said bunk portion is in its feeding position and said chute functions as a loading ramp when said bunk portion is in said loading position; and
a base portion for supporting said bunk portion above a ground surface, said base portion pivotally connected to said bunk portion.

12. The rotating feed bunk of claim 11, wherein pivoting connectors connect the base portion to the bunk portion.

13. The rotating feed bunk of claim 1 wherein said bunk portion pivots about a first axle extending from a first end of said bunk portion and a second axle extending from a second end of said bunk portion.

14. The rotating feed bunk of claim 13, wherein said base portion comprises a plurality of supports pivotally supporting said first axle and said second axle.

15. The rotating feed bunk of claim 11, wherein said base portion comprises a plurality of feet extending from a bottom end of said support portion providing additional stability to said support portion.

16. The rotating feed bunk of claim 11, further comprising a handle operably connected to said bunk portion for allowing a user to manually rotate said bunk portion between said feeding position and said loading position.

17. The rotating feed bunk of claim 11, further comprising a motor operably connected to said bunk portion wherein said motor rotates said bunk portion between said feeding position and said loading position.

18. The rotating feed bunk of claim 11, further comprising a stabilizing bar operably secured between said plurality of supports for providing added lateral stability to said plurality of supports.

19. The rotating feed bunk of claim 11, wherein said plurality of supports are vertically adjustable to raise or lower said bunk portion.

20. A rotating feed bunk comprising:
a bunk portion for holding animal feed, wherein said bunk portion defines a feed opening therein, wherein said bunk portion pivotally connects with a base portion thereby enabling the bunk portion to rotate between a feeding position where livestock may feed upon said animal feed, and a loading position where an individual can load said animal feed into said bunk portion, wherein said bunk portion comprises a chute extending from said bunk portion above said feed opening when in said feeding position wherein said chute shelters said opening from the elements when said bunk portion is in its feeding position and said chute functions as a loading ramp when said bunk portion is in said loading position, wherein said bunk portion pivots about a first axle extending from a first end of said bunk portion and a second axle extending from a second end of said bunk portion; and
a base portion for supporting said bunk portion above a ground surface, wherein said base portion comprises a plurality of supports pivotally supporting said first axle and said second axle, wherein said plurality of supports are vertically adjustable to raise or lower said bunk portion;
a handle operably connected to said bunk portion for allowing a user to manually rotate said bunk portion between said feeding position and said loading position; and
a motor operably connected to said bunk portion wherein said motor rotates said bunk portion between said feeding position and said loading position.
